(19) United States
(12) Patent Application Publication
(10) Pub. No.: US 2007/0110992 A1
(43) Pub. Date: May 17, 2007

(54) Block

(75) Inventors: Hisatoshi Ido, Toyota-shi (JP); Masao Sudo, Toyota-shi (JP)

Correspondence Address: DANIEL B. SCHEIN, PH.D., ESQ., INC., P. O. BOX 68128, Virginia Beach, VA, 23471, US

(73) Assignee: UNISON CORPORATION

(21) Appl. No.: 11/481,610

(22) Filed: Jul. 5, 2006

(30) Foreign Application Priority Data
Nov. 16, 2005 (JP) 2005-332195

(51) Int. Cl. B32B 3/26; B32B 3/06; B32B 9/00

(52) U.S. Cl. 428/318.4; 428/304.4; 428/307.3

(57) ABSTRACT

A block includes a block main body formed from an initial composition produced by mixing a first sand, a second sand, a ceramic aggregate, and cement. The mix rate of the sands and the cement is set so that the fineness modulus of the initial composition is 2.05 to 2.3. The block, which is manufactured under such a condition, includes a plurality of fine pores that form a continuous porous structure. Fine pores having a radius of 3.7 to 6500 nm have a fine pore volume of 0.02 to 0.04 ml/g and a specific surface area of 1.3 to 4 m²/g. The fine pores result in a gap rate of 18 to 28%.

### BACKGROUND OF THE INVENTION

The present invention relates to a block, and more particularly, to a block provided with functions for holding and absorbing water.

Japanese Laid-Open Patent Publication No. 2003-41509 describes a prior art example of a block used to pave roads, such as a road boundary block. The block described in this publication uses waste concrete, which is crushed into grains, as an aggregate. The block is manufactured from initial composition obtained by mixing the aggregate with cement. This forms many fine pores (fine gaps), which are continuous with each other, in the block so that the block has a continuous porous structure. To manufacture the block, the initial composition is subjected to a high level of vibration and compression and molded into a predetermined shape. The molded product is then cured for at least twenty-four hours in an atmosphere saturated with steam.

With the continuous porous structure in the block manufactured in this manner, a capillary phenomenon occurs in the block when the block is immersed in water. In such a state, the block has a water holding rate of 10 to 15% and a water absorption rate of about 7%. When the block is in a dry surface state (surface is dry but internal portion is saturated with moisture), the heat capacity increases and moisture vaporization is enhanced. As a result, the block produces an effect of lowering the temperature in the environment in which the block is used that continues for about one or two days. The mix rate of the aggregate and the cement of the block is set in a manner such that the block has a flexural strength of approximately 3.2 N/mm² so that the block complies with Japanese Architectural Standard Specification (JASS) 7M-101, which specifies the flexural strength as being greater than 3.0 N/mm².

In view of global warming prevention, blocks used to pave roads and etc. are required to improve the temperature lowering effect. To improve the temperature lowering effect of the block described in the above publication, a natural aggregate (e.g., mordenite) having a high holding capability needs to be mixed into the initial composition of the block. If such a natural aggregate is used, the holding rate and absorption rate of the block would increase. However, the flexural strength of the block may become less than 3.0 N/mm².

The present invention provides a block that improves the holding rate and absorption rate without lowering flexural strength.

### SUMMARY OF THE INVENTION

One aspect of the present invention is a block manufactured from an initial composition produced by mixing an aggregate and cement. The block includes a plurality of fine pores forming a continuous porous structure. The fine pores with a radius of 3.7 to 6500 nm have a fine pore volume of 0.02 to 0.04 ml/g and a specific surface area of 1.3 to 4 m²/g when measured by performing mercury intrusion porosimetry. The fine pores of the block resulting in a gap rate of 18 to 28%.

### BRIEF DESCRIPTION OF THE SEVERAL VIEWS OF THE DRAWING

The invention, together with objects and advantages thereof, may best be understood by reference to the following description of the presently preferred embodiments together with the accompanying drawings in which:

FIG. 1 is a perspective view of a block according to a first embodiment of the present invention;

FIG. 2 is a schematic diagram of a block manufacturing apparatus according to the first embodiment;

FIG. 3 is a schematic partial cross-sectional view of the block;

FIG. 4 is a schematic view showing a vaporization heat temperature test conducted on the block;

FIG. 5 is a graph showing the fine pore distribution in a block of example 1;

FIG. 6 is a graph showing changes of the vaporization heat temperature in blocks of example 1 and a comparative example; and

FIG. 7 is a perspective view showing a block of a modification.

### DETAILED DESCRIPTION OF THE PREFERRED EMBODIMENTS

### First Embodiment

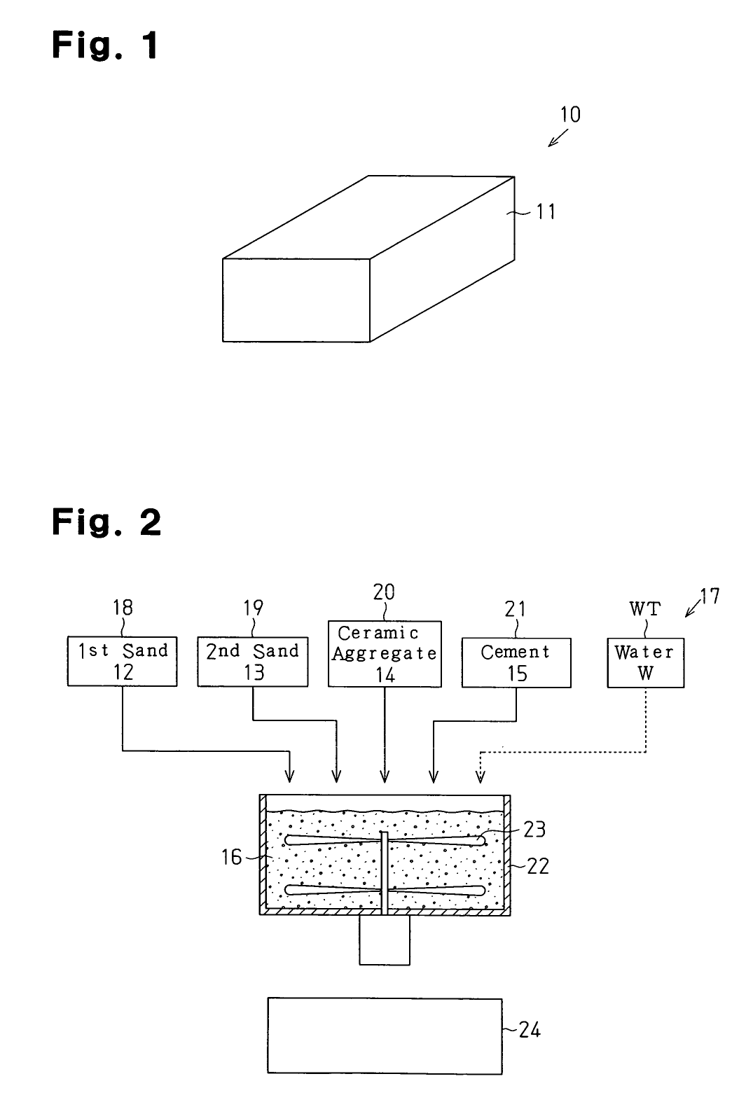

A first embodiment of the present invention will now be described with reference to FIGS. 1 to 4.

As shown in FIG. 1, a block 10 of the first embodiment is used, for example, to pave a road. The block 10 has a block main body 11, which is rectangular. As shown in FIG. 2, as an aggregate, the block main body 11 uses first sand 12, second sand 13, and a ceramic aggregate (artificial ceramic aggregate) 14. The block main body 11 is manufactured from an initial composition 16 obtained by mixing the sands 12 and 13 and the ceramic aggregate 14 with cement (also referred to as “bulk cement”) 15. The first sand 12 and the second sand 13 differ from each other in its grain size distribution. The second sand 13 is coarser than the first sand 12.

The sands 12 and 13, the ceramic aggregate 14, and the cement 15, which are used to manufacture the block 10, will now be described with reference to table 1 shown below.

TABLE 1
Distribution of First Sand, Second Sand,
Ceramic Aggregate, and Cement for Each Grain Size

| | Initial Composition | | | |
|---|---|---|---|---|
| | | | Ceramic | |
| | First | Second | Aggregate | |
| Grain Size | Sand 12 | Sand 13 | 14 | Cement 15 |
| Large Grain C | 0.1 | 13.4 | 83.1 | 0 |
| Medium Grain B | 90.1 | 85.8 | 16.9 | 0 |
| Small Grain A | 9.8 | 0.8 | 0 | 100 |

First sand: Blast-furnace slag, “BFS 1.2” available from Shin Nihon Seitetsu Kabushiki Kaisha, containing 42.80 wt % of calcium oxide, 0.97 wt % of sulfur, 0.01 wt % of sulfur trioxide, and 0.28 wt % of FeO.
Second sand: Cupola slag available from Toyota Jidosha Kabushiki Kaisha, Akechi Factory.
Ceramic Aggregate: Artificial ceramic aggregate, “Ecostar No. 5” available from Kabushiki Kaisha Hoshino Sansho, containing Wustite (FeO), magnesium-iron-aluminum-oxide (MgFeAlO) and amorphous silicate.
Cement: Normal Portland cement available from Ube Mitsubishi Cement Kabushiki Kaisha.

Table 1 shows the distribution of the sands 12 and 13, the ceramic aggregate 14, and the cement 15 for each grain size as a typical example. The sands 12 and 13, the ceramic aggregate 14, and the cement 16, which are used as the initial composition 16 in the preferred embodiment, are formed as grains. More specifically, the grains of the sands 12 and 13, the ceramic aggregate 14, and the cement 15 are all categorized into small grains A, medium grains B, or large grains C. A small grain A has a grain diameter of less than 0.15 mm. A medium grain B has a grain diameter of 0.15 mm or greater and smaller than 2.5 mm. The large grain C has a grain diameter of 2.5 mm or greater.

The grains of the first sand 12 are mostly categorized as medium grains B. More specifically, the first sand 12 contains 9.8 percent by mass of small grains A and 90.1 percent by mass of medium grains B. The first sand 12 further contains 0.1 percent by mass of large grains C.

The grains of the second sand 13 are mostly categorized as medium grains B. More specifically, the second sand 13 contains 0.8 percent by mass of small grains A and 85.8 percent by mass of medium grains B. The second sand 13 further contains 13.4 percent by mass of large grains C.

The grains of the ceramic aggregate 14 are mostly categorized as large grains C. More specifically, the ceramic aggregate 14 does not contain small grains A and contains 16.9 percent by mass of medium grains B and 83.1 percent by mass of large grains C. The grains of the cement 15 are all categorized as small grains A.

A block manufacturing apparatus for manufacturing the block 10 will now be described with reference to FIG. 2.

As shown in FIG. 2, a block manufacturing apparatus 17 includes a plurality of (four in the present embodiment) hoppers 18, 19, 20, and 21, which are arranged horizontally in line. The hopper 18 stores the first sand 12. The hopper 19 stores the second sand 13. The hopper 20 stores the ceramic aggregate 14. The hopper 21 stores the cement 15. A mixing vessel 22 is arranged below the hopers 18 to 21. The mixing vessel 22 is supplied with the sands 12 and 13, the ceramic aggregate 14, and the cement 15 via openings (not shown) formed in the bottom surfaces of the hoppers 18 to 21. The mixing vessel 22 is also supplied with a predetermined amount of water W from a water tank WT.

Blades 23 are arranged in the mixing vessel 22. The blades 23 rotate when driven by a motor (not shown). This evenly agitates the sands 12 and 13, the ceramic aggregate 14, the cement 15, and the water W. As a result, the initial composition 16 is produced with a slump value of zero (“slump” is an index showing the plasticity of concrete, and a slump value of zero indicates that the fluidity is close to zero).

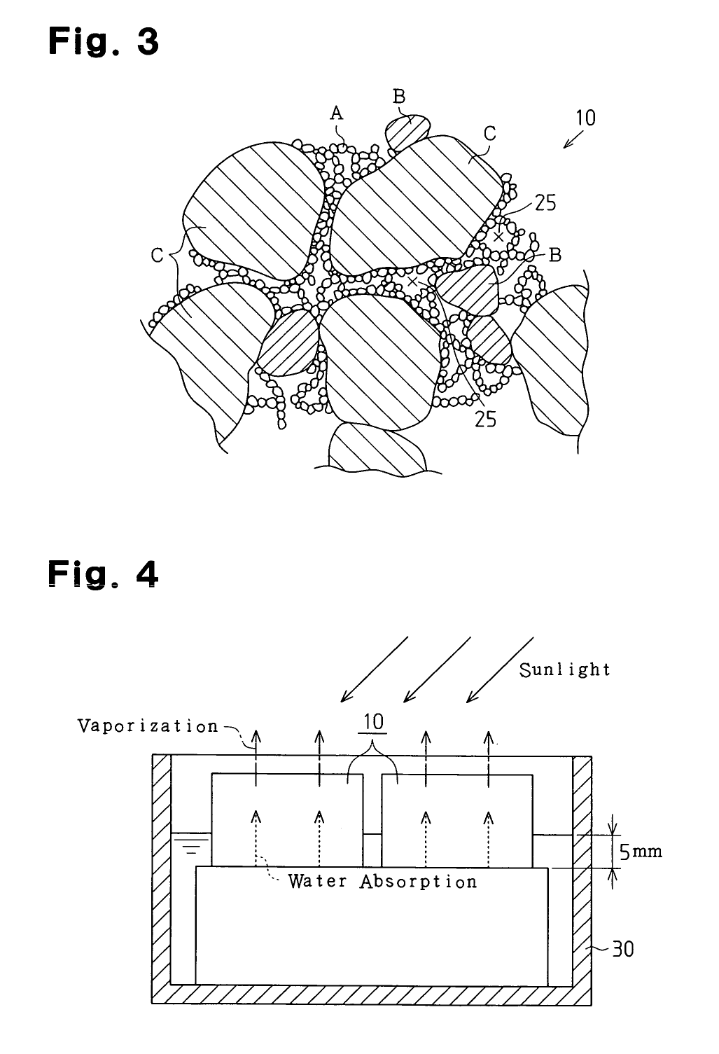

A mold 24 is arranged below the mixing vessel 22. The initial composition 16 in the mixing vessel 22 is supplied into the mold 24. The initial composition 16 supplied in the mixing vessel 22 is subjected to vibration to increase the filling rate of the initial composition 16 in the mixing vessel 22. The initial composition 16 is molded into a rectangular shape by the mold 24 and then removed from the mold 24. The material is then cured for a long period of time (at least 24 hours) to complete the manufacture of the block 10. A block 10 manufactured in this manner includes many fine pores (fine gaps) 25 that form a continuous porous structure as shown in FIG. 3. The continuous porous structure causes the capillary phenomenon in the block 10.

In the first embodiment, the mix rate of the sands 12 and 13, the ceramic aggregate 14, and the cement 15 is set in a manner such that the fineness modulus of the initial composition 16 is in a range of 1.8 to 2.35. The fineness modulus is generally an index indicating the coarseness of the grain size of aggregates (the sands 12 and 13 and the ceramic aggregate 14). Further, the fineness modulus is a value obtained by dividing the sum of the percentage by weight of grains that remain in sieves, which have a nominal sieve size of 80, 40, 20, 10, 5, 2.5, 1.2, 0.6, 0.3, and 0.15 mm, by one hundred. However, in the first embodiment, the fineness modulus does not indicate the coarseness of only the aggregate grains and indicates the coarseness of all the grains in the initial composition 16 including the grains of the cement 15.

To produce the initial composition 16 having the above fineness modulus (1.8 to 2.35), the sands 12 and 13, the ceramic aggregate 14, and the cement 15 are mixed, for example, in the manner described below. More specifically, the sands 12 and 13 are mixed in a manner such that the first sand 12 constitutes 58.3 percent by mass of the initial composition 16 and the second sand 13 constitutes 5.6 percent by mass of the initial composition 16. Further, the ceramic aggregate 14 and the cement 15 are mixed in a manner such that the ceramic aggregate 14 constitutes 14.5 percent by mass of the initial composition 16 and the cement 15 constitutes 19.4 percent by mass of the initial composition 16.

As described above, in the first embodiment, the cement 15, which has been used in the prior art only as a curing material (also referred to as a “binder”) for curing the initial composition 16, is in the form of grains like the sands 12 and 13 and the ceramic aggregate 14, which function as aggregates. The initial composition 16 is formed by mixing the sands 12 and 13, the ceramic aggregate 14, and the cement 15 in the manner described above, and then mixing 2.2 percent by mass of the water W to produce the initial composition 16.

A block 10 manufactured in this manner has many fine pores 25 that form a continuous porous structure. The gap rate of the block 10 (the rate occupied by air in the block 10) is 18 to 28% by volume of the block main body 11. Further, the block 10 is manufactured so that when measured by performing mercury intrusion porosimetry, the fine pore volume of fine pores 25 in the block 10 having a radius of 3.7 to 6500 nm (37 to 65000 Å) is 0.02 to 0.04 ml/g (e.g., 0.025 ml/g) and the specific surface area of such fine pores 25 is 1.3 to 4 m²/g (e.g., 1.7 m²/g). When the block 10 of the first embodiment is immersed in water, a capillary phenomenon occurs with the continuous fine pores in a satisfactory manner so that water is optimally absorbed into the block 10. The fine pores 25 having a radius of 3.7 to 6500 nm in the block 10 hold the water absorbed in the block 10.

The first embodiment has the advantages described below.

(1) If the fine pores 25 having a radius of 3.7 to 6500 nm have a specific surface area of 1.3 to 4 m²/g and a fine pore volume greater than 0.04 ml/g, the hollow part of the block 10 (the gap rate of the block 10) would increase, and the flexural strength of the block 10 may decrease to less than, for example, 3.0 N/mm². If the fine pores 25 having a radius of 3.7 to 6500 nm have a specific surface area of 1.3 to 4 m²/g and a fine pore volume of less than 0.02 ml/g, the amount of water entering the fine pores 25 would decrease because of the small fine pore volume. As a result, the water absorption rate of the block 10 may decrease, and the water holding rate of the block 10 may decrease.

If the fine pores 25 having a radius of 3.7 to 6500 nm have a specific surface area of 0.02 to 0.04 ml/g and a fine pore volume greater than 4 m²/g, the hollow part of the block 10 (the gap rate of the block 10) would increase, and flexural strength of the block 10 may decrease to less than, for example, 3.0 N/mm². If the fine pores 25 having a radius of 3.7 to 6500 nm have a fine pore volume of 0.02 to 0.04 ml/g and a specific surface area of less than 1.3 m²/g, the amount of water entering the fine pores 25 would decrease because of the small specific surface area. As a result, the water absorption rate of the block 10 may decrease, and the water holding rate of the block 10 may decrease.

Further, if the gap rate of the block 10 is less than 18%, the absorption capability of the block 10, which results from the capillary phenomenon in the block 10, decreases. This may decrease the water absorption rate of the block 10. Further, the water holding rate of the block 10 may decrease. If the gap rate of the block 10 is higher than 28%, the hollow part (i.e., the gap rate of the block 10) becomes too high. In this case, the flexural strength of the block 10 may become less than, for example, 3.0 N/mm².

In the first embodiment, however, the block 10 is formed so that the fine pores 25 having a radius of 3.7 to 6500 nm have a fine pore volume of 0.02 to 0.04 ml/g and a specific surface area of 1.3 to 43.5 m²/g so that the block 10 has a gap rate of 18 to 28%. This improves the water holding rate and the water absorption rate of the block 10 without lowering flexural strength of the block 10.

(2) If the fineness modulus of the initial composition 16 is less than 1.8, the rate of the large grains C mixed in the initial composition 16 becomes too small. Thus, the flexural strength of the block 10 may decrease. If the fineness modulus of the initial composition 16 is greater than 2.3, the rate of the large grains C mixed in the initial composition 16 becomes too high. Thus, the grain density in the block 10 may increase. As a result, the absorption rate and the holding rate of the block 10 may decrease compared to the first embodiment. In the first embodiment, the mix rate of the sands 12 and 13, the ceramic aggregate 14, and the cement 15 is set so that the fineness modulus of the initial composition 16 is 1.8 to 2.35. This increases flexural strength of the block 10 while maintaining the absorption rate and the holding rate of the block 10.

### Second Embodiment

A second embodiment of the present invention will now be described. The second embodiment differs from the first embodiment in aggregates of an initial composition. The second embodiment will be described focusing on its differences from the first embodiment. Components in the second embodiment that are the same or like in the first embodiment are given the same reference numerals and will not be described.

TABLE 2
Distribution of First Sand, Second Sand,
Particulate Ceramic, and Cement of Each Grain Size

| | Initial Composition | | | |
|---|---|---|---|---|
| | First | Second | Particulate | |
| Grain Size | Sand 12 | Sand 13 | Ceramic 26 | Cement 15 |
| Large Grain C | 0.1 | 13.4 | 0 | 0 |
| Medium grain B | 90.1 | 85.8 | 88 | 0 |
| Small Grain A | 9.8 | 0.8 | 12 | 100 |

As shown in table 2, a block 10 of the second embodiment uses sands 12 and 13 and particulate ceramic 26 as aggregates. The block 10 is manufactured from an initial composition 16 that is produced by mixing the sands 12 and 13 and the particulate ceramic 26 with cement 15. The particulate ceramic 26 has an absorption rate of 12% or greater. The particulate ceramic 26 has many fine pores forming a porous structure. The porous structure results in the capillary phenomenon in the particulate ceramic 26. Thus, the particulate ceramic 26 has a higher water absorption rate than the first sand 12 (with a water absorption rate of substantially 1.69%) and the second sand 13 (with a water absorption rate of substantially 1.9%). More specifically, the particulate ceramic 26 functions as a high water absorption aggregate having a relatively high absorption capability, the second sand 13 functions as a medium-level water absorption aggregate having a medium-level water absorption capability, and the first sand 12 functions as a low water absorption aggregate having a relatively low water absorption capability in the second embodiment.

The grains of the particulate ceramic 26 are mostly categorized as medium grains B as shown in table 2. More specifically, the particulate ceramic 26 contains 12 percent of small grains A by mass, and 88 percent of medium grains B by mass. The particulate ceramic 26 used in the present embodiment contains no large grains C.

It is preferable that the mix rate of the sands 12 and 13, the particulate ceramic 26, and the cement 15 be set in the manner described below to produce the initial composition 16 with substantially the same fineness modulus (1.8 to 2.3) as that in the first embodiment. More specifically, the sands 12 and 13 and the particulate ceramic 26 are mixed so that the first sand 12 constitutes 55.8 percent by mass of the initial composition 16, the second sand 13 constitutes 5.3 percent by mass of the initial composition 16, and the particulate ceramic 26 constitutes 14.8 percent by mass of the initial composition 16. Further, the cement 15 is mixed to constitute 19.6 percent by mass of the initial composition 16.

The sands 12 and 13, the particulate ceramic 26, and the cement 15 are mixed so that the mix rate of the grains A to C are as described above. Water W is then mixed to constitute 4.5 percent by mass of the initial composition 16.

The second embodiment has the advantages described below in addition to the advantages of the first embodiment.

(3) The initial composition 16 contains the particulate ceramic 26, which is a high water absorption aggregate. Thus, the block 10 manufactured from the initial composition 16 of the second embodiment has a higher water absorption rate and water holding rate as compared with the block 10 of the first embodiment.

### EXAMPLES

Examples and a comparative example of the above embodiments will now be described.

### Example 1

The sands 12 and 13, the particulate ceramic 26, and the cement 15 were mixed in a manner such that the first sand 12 constitutes 55.8 percent by mass of the initial composition 16, the second sand 13 constitutes 5.3 percent by mass of the initial composition 16, the particulate ceramic 26 constitutes 14.8 percent by mass of the initial composition 16, and the cement 15 constitutes 19.6 percent by mass of the initial composition 16. The water W was then mixed to constitute 4.5 percent by mass of the initial composition 16. The initial composition 16 was then evenly agitated in the mixing vessel 22. Afterward, the initial composition 16 was supplied into the mold 24 and cured to complete the manufacture of the block 10.

### Example 2

The sands 12 and 13 and the ceramic aggregate 14 were mixed in a manner such that the first sand 12 constitutes 58.3 percent by mass of the initial composition 16, the second sand 13 constitutes 5.6 percent by mass of the initial composition 16, and the ceramic aggregate 14 constitutes 14.5 percent by mass of the initial composition 16. Further, the cement 15 was mixed to constitute 19.4 percent by mass of the initial composition 16. The water W was then mixed to constitute 2.2 percent by mass of the initial composition 16. The initial composition 16 was then evenly agitated in the mixing vessel 22. The processes performed thereafter were the same as in example 1.

### Comparative Example 1

The first sand 12 and gravel were used as aggregates. The first sand 12, the gravel, and the cement 15 were mixed to produce the initial composition 16, and the block 10 was manufactured from the initial composition 16. The first sand 12, the gravel, and the cement 15 were mixed in a manner such that the first sand 12 constitutes 58.1 percent by mass of the initial composition 16, the gravel constitutes 18.8 percent by mass of the initial composition 16, and the cement 15 constitutes 16.6 percent by mass of the initial composition 16. The water W was then mixed to constitute 6.5 percent by mass of the initial composition 16. The initial composition 16 was then evenly agitated in the mixing vessel 22. The processes performed thereafter were the same as in example 1.

The gravel contains 0.2 percent by mass of small grains A, 1.6 percent by mass of medium grains B, and 98.2 percent by mass of large grains C.

When the initial composition 16 is produced by setting the mix rate of the sands 12 and 13, the ceramic aggregate 14, the particulate ceramic 26, and the cement 15 as in examples 1 and 2 and comparative example 1, the mixing rate of the grains A to C in the initial composition 16 is as shown in tables 1, 2, and 3. More specifically, the mixing rate of the grains A is higher in the blocks 10 of examples 1 and 2 than in the block 10 of comparative example 1.

TABLE 3

| | | | Comparative |
|---|---|---|---|
| | Example 1 | Example 2 | Example 1 |
| | (mass %) | (mass %) | (mass %) |
| Large Grain C | 0.8 | 9.1 | 27.7 |
| Medium grain B | 71.1 | 62.5 | 51.1 |
| Small Grain A | 23.6 | 23.3 | 14.7 |
| Water W | 4.5 | 5.1 | 6.5 |

[Discussion]

The gap rate, the fineness modulus, the fine pore volume, the specific surface area, the water absorption capability, the water retaining capability, the flexural strength, the temperature lowering effect, and the vaporization heat temperature of the blocks 10 of examples 1 and 2 and comparative example 1 were measured. To measure the gap rate of each block 10, the total mass of the sands 12 and 13, the ceramic aggregate 14, the particulate ceramic 26, the cement 15, and the water W was first calculated (estimated) in a process performed before manufacturing the block 10. Then, the gap rate was detected using the calculated total mass and the mass (weight) of the block 10 measured immediately subsequent to the molding process (before the water contained in the initial composition 16 vaporizes). The calculation result obtained in this way involves not only fine pores 25 that form the continuous porous structure of the block 10 but also fine pores 25 that are not continuous with other fine pores 25 (that is, fine pores that have almost no absorption and holding functions). The gap rate of each block 10 may alternatively be detected after the manufacture of the block 10 based on the mass of the block 10 in a dry surface state (surface is dry but internal portion is saturated with water) and the mass of the block 10 in an absolutely dry state (in which its holding rate is almost zero). The calculation result obtained in this way does not involve the fine pores 25 that are not continuous with other fine pores 25. However, the measurement methods of the gap rate yield substantially equal measurement results (calculation results).

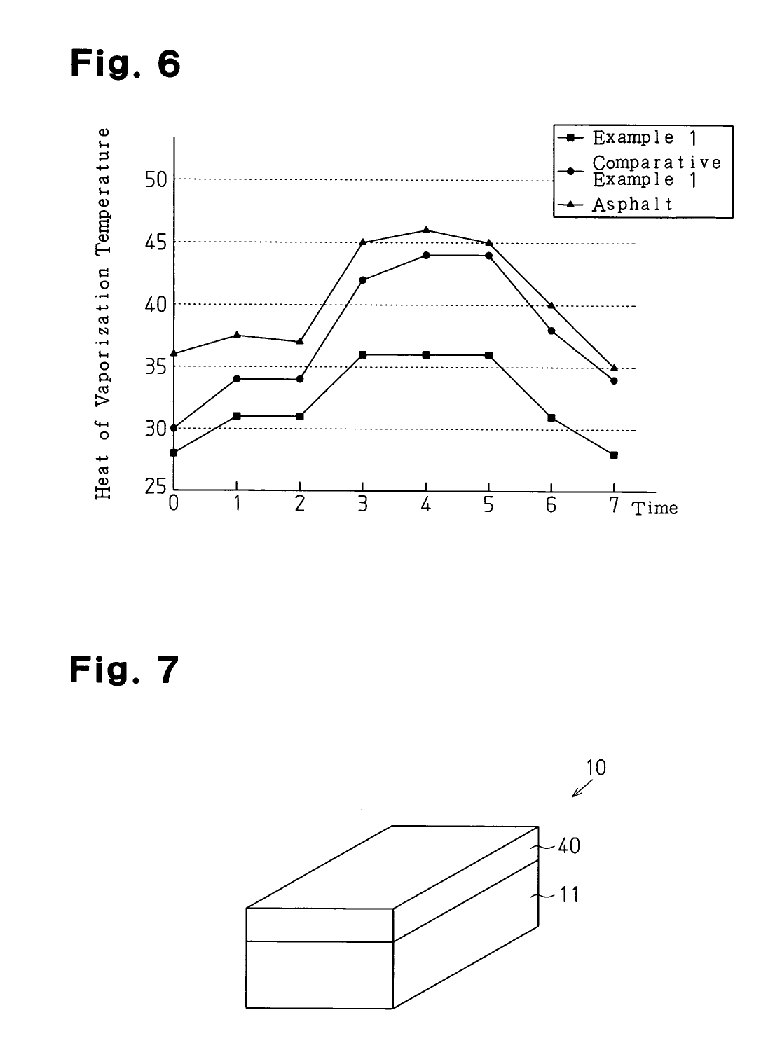

The radius distribution of the fine pores 25 having a radius of 3.7 to 6500 nm (37 to 6500 Å) in the block 10 is measured by performing mercury intrusion porosimetry using a mercury porosimeter (Porosimeter Series 2000 manufactured by Carlo Erba Instruments). The fine pore volume and the specific surface area were calculated based on the measured fine pore radius distribution. The water absorption capability of each block 10 was measured in accordance with the “test methods for density and water absorption rate of coarse aggregates” specified by Japan Industrial Standards (JIS) A1110. The water holding capability of each block 10 was measured by calculating the difference between the mass of the block 10 in a dry surface state and the mass of the block 10 in an absolutely dry state and dividing the difference by the mass of the block 10 in an absolutely dry state. The flexural strength of each block 10 was measured in accordance with the “precast non-reinforced concrete products” specified by JIS A5371. The temperature lowering effect of each block 10 was measured with the block 10 in a surface dry state. The vaporization heat temperature of each block 10 was measured by arranging the block 10 in a water bath 30 storing water. The block 10 was arranged in the bath 30 in a manner such that its lower portion was immersed in water for about 5 mm. The temperature in the vicinity of the top surface of the block 10 was measured. FIG. 6 shows the vaporization heat temperature of each block 10.

TABLE 4

| | | | Comparative |
|---|---|---|---|
| | Example 1 | Example 2 | Example 1 |
| Gap Rate | 22.6 | 22.8 | 7.3 |
| Fineness Modulus | 2.05 | 2.2 | 3.2 |
| Fine Pore Volume | 0.0375 | 0.025 | 0.0245 |
| (ml/g) | | | |
| Specific Surface | 2.54 | 1.7 | 2.21 |
| Area (m²/g) | | | |

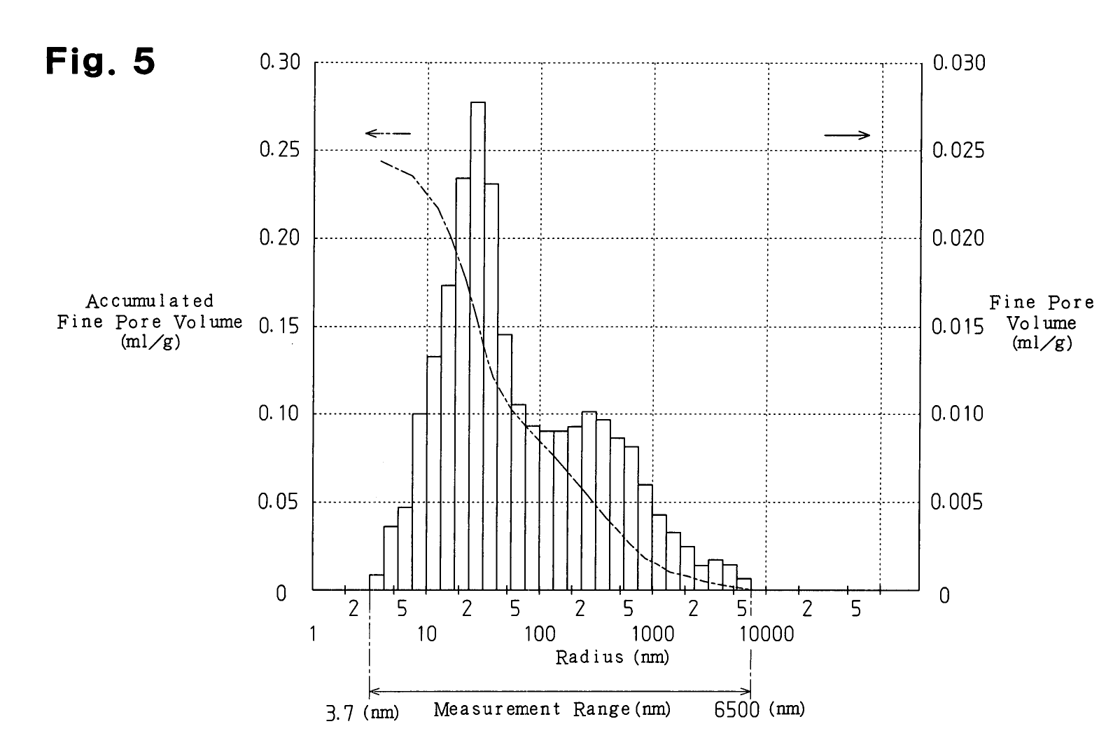

As shown in table 4 and FIG. 5, the gap rate of the blocks 10 of examples 1 and 2 is 18 to 28%, whereas the gap rate of the block 10 of comparative example 1 is 7.3% (<18%). Further, for the blocks 10 of examples 1 and 2, the fine pore volume of the fine pores 25 having a radius of 3.7 to 6500 nm is 0.02 to 0.04 ml/g and the specific surface area of the fine pores 25 having a radius of 3.7 to 6500 nm is 1.3 to 4 m²/g. The accumulated fine pore volume on the left vertical axis in FIG. 5 represents values obtained by adding the fine pore volume of the fine pores 25 in an order starting with fine pores 25 having a larger radius. The accumulated fine pore volume is indicated by the dashed line in FIG. 5. Further, the fine pore volume on the right vertical axis in FIG. 7 is indicated by a bar graph.

TABLE 5

| | | | Comparative |
|---|---|---|---|
| | Example 1 | Example 2 | Example 1 |
| Water Absorption | 13.5 | 9.1 | 3.7 |
| Rate (%) | | | |
| Water Holding | 25.1 | 19.3 | 7.6 |
| Rate (%) | | | |
| Temperature | 3-4 | 2-3 | 0 |
| Lowering Effect | | | |
| (Number of Days) | | | |
| Flexural Strength | 3.76 | 6.63 | 5 |
| (N/mm²) | | | |

As table 5 shows, the blocks 10 of examples 1 and 2 have a higher water absorption rate and a higher water holding rate than the block 10 of comparative example 1. The blocks 10 of examples 1 and 2 have a water absorption rate of 7.5% or greater and a water holding rate of 16% or greater. The temperature lowering effect of the block 10 in comparative example 1 does not last even for one day, whereas the temperature lowering effect the block 10 in example 2 lasts for two or three days, and the temperature lowering effect of the block 10 in example 1 lasts for three to four days.

The block 10 of comparative example 1 has a flexural strength that is greater than 3.0 N/mm². However, when, for example, mordenite, which is a natural aggregate having a high holding capability, is mixed in the initial composition 16 of the block 10 in comparative example 1 to improve the absorption rate (to or above 7.5%), the flexural strength of the block 10 manufactured from this initial composition 16 may decrease to or below 3.0 N/mm². The block 10 of example 1 has a flexural strength of at least 3.0 N/mm² and has an improved absorption rate (15% or higher) and an improved holding capability (20% or higher) although the block 10 of example 1 is manufactured from the initial composition 16 containing the particulate ceramic 26 as a high water absorption aggregate. Further, the block 10 of example 2 has a fineness modulus of 2.05 or greater but 2.3 or less. As a result, the block 10 of example 1 has a flexural strength that is greater than 5.0 N/mm².

TABLE 6

| | 0 | 1 | 2 | 3 | 4 | 5 | 6 | 7 |
|---|---|---|---|---|---|---|---|---|
| Ambient Air | 29 | 30 | 30 | 34 | 34 | 34 | 33.5 | 30 |
| Temperature | | | | | | | | |
| Asphalt | 36 | 37.5 | 37 | 45 | 46 | 45 | 40 | 35 |
| Example 1 | 28 | 31 | 31 | 36 | 36 | 36 | 31 | 28 |
| Comparative | 30 | 34 | 34 | 42 | 44 | 44 | 38 | 34 |
| Example 1 | | | | | | | | |

As shown in table 6 and FIG. 6, the vaporization heat temperature of the block 10 in comparative example 1 increases as the ambient air temperature increases in the same manner as the vaporization heat temperature of asphalt. However, the vaporization heat temperature of the block 10 of example 1 is lower by about 10° C. than the temperature of asphalt. In this respect, the block 10 of example 1 has a better temperature lowering effect than the block 10 of comparative example 1.

It should be apparent to those skilled in the art that the present invention may be embodied in many other specific forms without departing from the spirit or scope of the invention. Particularly, it should be understood that the present invention may be embodied in the following forms.

In the above embodiments, the mix rate of the sands 12 and 13, the ceramic aggregate 14, the particulate ceramic 26, and the cement 15 may be set in a manner such that the fineness modulus of the initial composition 16 is 2.05 to 2.35. More specifically, when the fineness modulus of the initial composition 16 is 1.8 or greater but less than 2.05, the flexural strength of the block 10 increases to 3.0 N/mm² or greater but cannot reach 5.0 N/mm². However, when the mix rate of the sands 12 and 13, the ceramic aggregate 14, the particulate ceramic 26, and the cement 15 is set in a manner such that the fineness modulus of the initial composition 16 is 2.05 or greater, the flexural strength of the block 10 increases to 5.0 N/mm² or greater. In this way, the flexural strength of the block 10 is further improved.

In the above embodiments, the block 10 may include a water permeable layer 40 having water permeability that is greater than that of the block main body 11. The water permeable layer 40 is arranged at the surface side of the block main body 11 (the surface side when the block 10 is arranged to pave a road) as shown in FIG. 7. In this case, water entering the water permeable layer 40 is readily discharged from the water permeable layer 40. This prevents the surface of the block 10 from being stained by moss and mold.

In the above embodiments, for example, sepiolite may be used as a high water absorption aggregate. It is preferable that the high water absorption aggregate be mixed in the initial composition 16 in a manner such that the block 10 manufactured using such an aggregate has a flexural strength of 3.0 N/mm² or higher. Sepiolite is a natural material having a moisture absorption and desorption characteristic.

Further, crushed red roof tiles may be used as the high water absorption aggregate.

In the above embodiments, crushed ceramics grains, chamotte, glass cullet, incinerated ash, ferronickel slag, and copper slag may be used as aggregates.

In the above embodiments, the block 10 may be used as a block used for constructing walls.

In the above embodiments, the block 10 may have any shape (e.g., a spherical shape).

It is preferable that the high water absorption aggregate have an absorption rate of 12% or higher and include many fine pores that form a continuous porous structure.

The present examples and embodiments are to be considered as illustrative and not restrictive, and the invention is not to be limited to the details given herein, but may be modified within the scope and equivalence of the appended claims.

What is claimed is:

1. A block manufactured from an initial composition produced by mixing an aggregate and cement, the block comprising:
a plurality of fine pores forming a continuous porous structure;
the fine pores with a radius of 3.7 to 6500 nm having a fine pore volume of 0.02 to 0.04 ml/g and a specific surface area of 1.3 to 4 m²/g when measured by performing mercury intrusion porosimetry; and
the fine pores of the block resulting in a gap rate of 18 to 28%.

2. The block according to claim 1, wherein the aggregate and the cement are formed as grains, and the aggregate and the cement have a mix rate that is set so that the initial composition has a fineness modulus of 1.8 to 2.35.

3. The block according to claim 1, wherein the aggregate and the cement are formed as grains, and the aggregate and the cement have a mix rate that is set so that the initial composition has a fineness modulus of 2.05 to 2.35.

4. The block according to claim 1, wherein the aggregate includes a high water absorption aggregate, which has a relatively high water absorption capability, and a low water absorption aggregate, which has a relatively low water absorption capability.

5. The block according to claim 1, further comprising:
a block main body manufactured from the initial composition; and
a water permeable layer formed on a surface of the block main body and having a higher water permeability than the block main body.

6. The block according to claim 1, wherein the block is used for paving a road.
